(19) United States
(12) Patent Application Publication
(10) Pub. No.: US 2009/0025631 A1
(43) Pub. Date: Jan. 29, 2009

(54) GAS-TIGHT MODULE AND EXHAUST METHOD THEREFOR

(75) Inventor: Tsuyoshi MORIYA, Nirasaki-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 12/174,158

(22) Filed: Jul. 16, 2008

Related U.S. Application Data
(60) Provisional application No. 60/983,287, filed on Oct. 29, 2007.

(30) Foreign Application Priority Data
Jul. 27, 2007 (JP) 2007-195588

(51) Int. Cl. B05C 11/00

(52) U.S. Cl. 118/50; 118/600

(57) ABSTRACT

A gas-tight module capable of preventing the collapse of a pattern formed on a principal surface of a substrate, without lowering throughput. A load lock module of a substrate processing system includes a transfer arm, a chamber, and a load lock module exhaust system. A plate-like member is disposed in the chamber such as to face the principal surface of a wafer transferred into the chamber. An exhaust passage isolated from the remaining space in the chamber is defined by the wafer and the plate-like member at a location right above the principal surface of the wafer. The sectional area of the exhaust passage is smaller than that of the remaining space in the chamber.

### BACKGROUND OF THE INVENTION

1. Field of the Invention

The present invention relates to a gas-tight module and an exhaust method therefor, and more particularly, to a gas-tight module having a chamber into which is transferred a substrate formed with a pattern on its principal surface by being subjected to predetermined processing.

2. Description of the Related Art

A substrate processing system for performing predetermined processing such as plasma processing on a wafer as a to-be-processed substrate includes a process module that carries out plasma processing on a wafer housed therein, a load lock module that transfers a wafer into the process module and transfers the processed wafer out from the process module, and a loader module that takes out a wafer from a container in which wafers are housed and transfers the taken-out wafer to the load lock module.

The load lock module of the substrate processing system usually includes a chamber for receiving a wafer. The load lock module operates as follows: After a wafer is received in the chamber at atmospheric pressure, the inside of the chamber is vacuum-exhausted to a predetermined pressure, and the wafer is transferred into the process module, with a gate between the load lock module and the process module being open. After completion of plasma processing on the wafer in the process module, the processed wafer is transferred out from the process module. Subsequently, the gate is closed, the internal pressure of the chamber is restored to atmospheric pressure, and the wafer is transferred into the loader module (see, for example, Japanese Laid-open Patent Publication No. 2006-128578).

In the above described load lock module, a wafer is subjected to plasma processing, whereby a pattern is formed on the principal surface of the wafer. However, when the wafer formed with the pattern is received in the chamber at atmospheric pressure and the inside of the chamber is then vacuum-exhausted, the pattern formed on the principal surface of the wafer is sometimes collapsed.

A possible mechanism of the pattern collapse is considered as follows: As shown in FIG. 8, gas molecules m present in the chamber between various portions of the pattern P collide with the pattern P when the chamber is vacuum-exhausted, and the pattern P is collapsed by the kinetic momentum of the gas molecules m that collide with the pattern P.

The pattern collapse on the principal surface of the wafer causes short circuit or other problems in semiconductor devices fabricated on the wafer, thereby lowering the yield of semiconductor devices finally fabricated.

Conventionally, therefore, the kinetic momentum of gas molecules in the chamber of the load lock module is decreased by reducing the speed of vacuum exhaustion of the chamber so as to prevent the pattern collapse. However, in the case of reducing the vacuum exhaust speed, a long time is required to attain a desired vacuum level, posing a problem that the throughput of the substrate processing system is remarkably lowered.

### SUMMARY OF THE INVENTION

The present invention provides a gas-tight module and an exhaust method therefor capable of preventing collapse of a pattern formed on a principal surface of a substrate, without causing a reduction in throughput.

According to a first aspect of this invention, there is provided a gas-tight module comprising a chamber into which is transferred a substrate formed with a pattern on its principal surface by being subjected to predetermined processing, and a plate-like member disposed to face the principal surface of the substrate transferred into the chamber.

With the gas-tight module of this invention, a plate-like member is disposed to face a principal surface of a substrate, and an exhaust passage isolated from the remaining space in a chamber is defined by the substrate and the plate-like member at a location right above the principal surface of the substrate. The exhaust passage has a sectional area smaller than that of the remaining space in the chamber, and therefore has a conductance smaller than that of the remaining space in the chamber. As a result, at the time of vacuum exhaustion, there occurs a reduction in the kinetic momentum of gas molecules at a location right above the principal surface of the substrate, i.e., in the kinetic momentum of gas molecules present between portions of a pattern formed on the principal surface of the substrate, and therefore the pattern is hardly collapsed by the collision of the gas molecules with the pattern. An amount of exhaust flow right above the principal surface of the substrate in the chamber is relatively extremely small, and therefore a change in the conductance of the exhaust passage hardly affects the conductance of the exhaust flow in the entire chamber. As a result, the exhaust time required for vacuum exhaustion is not made long. This makes it possible to prevent the collapse of the pattern formed on the principal surface of the substrate, without causing a reduction in the throughput of the substrate processing system.

The plate-like member can be disposed at a distance equal to or less than 5 mm from the principal surface of the wafer.

In that case, the plate-like member is disposed at a distance of 5 mm or less from the principal surface of the substrate, and therefore it is ensured that the conductance of the exhaust passage defined between the substrate and the plate-like member is made small enough to prevent the pattern collapse. This makes it possible to positively prevent the collapse of the pattern formed on the principal surface of the substrate.

The plate-like member can have a mesh structure or a porous structure.

In that case, the plate-like member has a mesh structure or a porous structure, and it is therefore possible to prevent the conductance of the exhaust passage defined between the substrate and the plate-like member from being too small more than necessary, whereby the inside of the chamber can rapidly be vacuum-exhausted.

The plate-like member can be one subjected to slit processing.

In that case, the plate-like member is one subjected to slit processing and it is therefore possible to prevent the conductance of the exhaust passage defined by the substrate and the plate-like member from being too small more than necessary, whereby the inside of the chamber can rapidly be vacuum-exhausted.

The plate-like member can be formed with a plurality of holes extending therethrough.

In that case, the plate-like member has a plurality of holes formed to extend therethrough, and therefore part of gas present right above the principal surface of the substrate is exhausted by passing through the holes. As a result, at the time of vacuum exhaustion, part of gas flows from the principal surface of the substrate toward the plate-like member, i.e., flows parallel to the pattern formed on the principal surface. This makes it possible to prevent part of gas molecules from colliding with the pattern, thereby positively preventing the pattern collapse.

The plurality of holes can be formed in the plate-like member so as to extend perpendicular to the principal surface of the substrate.

In that case, the holes extending through the plate-like member are formed in the direction perpendicular to the principal surface of the substrate. Thus, it is ensured that gas passing through the holes at the time of vacuum exhaustion flows parallel to the pattern formed on the principal surface.

The gas-tight module can include an exhaust apparatus disposed to face the principal surface of the substrate and adapted to exhaust inside of the chamber.

In that case, an exhaust apparatus for exhausting the inside of the chamber is disposed to face the principal surface of the substrate, and it is therefore ensured that gas passing through the holes at vacuum exhaustion flows parallel to the pattern formed on the principal surface of the substrate.

The gas-tight module can include a gas supply unit adapted to supply a light element gas into the chamber.

In that case, a light element gas is supplied into the chamber, whereby the gas within the chamber can be replaced with the light element gas. As a result, at the time of vacuum exhaustion, the kinetic momentum of gas molecules right above the principal surface of the substrate, i.e., gas molecules present between portions of the pattern formed on the principal surface of the substrate can be decreased, thus making it possible to positively prevent the collapse of the pattern formed on the principal surface of the substrate.

The gas-tight module can include a separation unit adapted to separate the plate-like member and the principal surface of the substrate away from each other.

In that case, the plate-like member and the principal surface of the substrate are separated away from each other, and therefore the conductance of the exhaust passage defined by the substrate and the plate-like member can be controlled. Furthermore, by controlling an amount of separation between the plate-like member and the substrate according to the pressure in the chamber during the vacuum exhaustion, the conductance of the exhaust passage can properly be controlled according to the pressure in the chamber during the vacuum exhaustion.

According to a second aspect of this invention, there is provided a gas-tight module comprising a chamber into which is transferred a substrate formed with a pattern on its principal surface by being subjected to predetermined processing, and a substrate lifting unit adapted to lift the substrate toward a portion of the chamber that faces the principal surface of the substrate transferred into the chamber.

With the gas-tight module according to the second aspect of this invention, a substrate is lifted toward a portion of the chamber facing the principal surface of the substrate. At that time, an exhaust passage isolated from the remaining space in the chamber is defined at a location right above the principal surface of the substrate by the substrate and the chamber portion. The exhaust passage has a sectional area smaller than that of the remaining space in the chamber, and therefore the conductance of the exhaust passage can be made smaller than that of the remaining space in the chamber, thereby achieving effects similar to those attained by the gas-tight module of the first aspect of this invention.

According to a third aspect of this invention, there is provided an exhaust method for a gas-tight module having a chamber into which is transferred a substrate formed with a pattern on its principal surface by being subjected to predetermined processing, the method comprising a disposing step of disposing a plate-like member in the chamber so as to face the principal surface of the substrate transferred into the chamber, and an exhausting step of exhausting inside of the chamber.

With the exhaust method according to the third aspect of this invention, effects similar to those attained by the gas-tight modules according to the first and second aspects of this invention can be achieved.

The exhaust method can include a low vacuum exhaustion step of exhausting the inside of the chamber to a low vacuum prior to the exhausting step, and a gas supply step of supplying a light element gas into the chamber exhausted to the low vacuum.

In that case, the inside of the chamber is exhausted to a low vacuum and a light element gas is supplied into the chamber, whereby gas within the chamber is replaced by the light element gas. As a result, at the time of vacuum exhaustion, the momentum of gas molecules right above the principal surface of the substrate, i.e., gas molecules present between portions of the pattern formed on the principal surface of the substrate can be decreased, whereby the collapse of the pattern on the principal surface of the substrate can positively be prevented.

According to a fourth aspect of this invention, there is provided an exhaust method for a gas-tight module having a chamber into which is transferred a substrate formed with a pattern on its principal surface by being subjected to predetermined processing, the method comprising a substrate lifting step of lifting the substrate toward a portion of the chamber that faces the principal surface of the substrate transferred into the chamber, and an exhaust step of exhausting inside the chamber.

With the exhaust method of the fourth aspect of this invention, effects similar to those attained by the gas-tight modules according to the first and second aspects of this invention can be achieved.

Further features of the present invention will become apparent from the following description of an exemplary embodiment with reference to the attached drawings.

### BRIEF DESCRIPTION OF THE DRAWINGS

FIG. 1 is a section view schematically showing the construction of a substrate processing system having a gas-tight module according to one embodiment of this invention;

FIG. 2 is a view for explaining an exhaust process as an exhaust method for a load lock module which is the gas-tight module of the embodiment;

FIG. 3 is a graph showing a relation between pressure in a chamber of the load lock module and exhaust time for which the chamber is vacuum-exhausted;

FIG. 4A to FIG. 4C are process diagrams for explaining a modification of the exhaust process, as an exhaust method for the load lock module;

FIG. 5 is a view for explaining an exhaust process as another modification of the exhaust method for the load lock module;

FIG. 6 is a view for explaining a modification of the load lock module, which is the gas-tight module according to the embodiment;

FIG. 7 is a view for explaining another modification of the load lock module; and

FIG. 8 is a view for explaining a possible mechanism of collapse of a pattern formed on a principal surface of a substrate at the time of vacuum exhaustion.

### DETAILED DESCRIPTION OF THE PREFERRED EMBODIMENT

The present invention will now be described in detail below with reference to the drawings showing a preferred embodiment thereof.

First, a substrate processing system including a gas-tight module of one embodiment of this invention will be described.

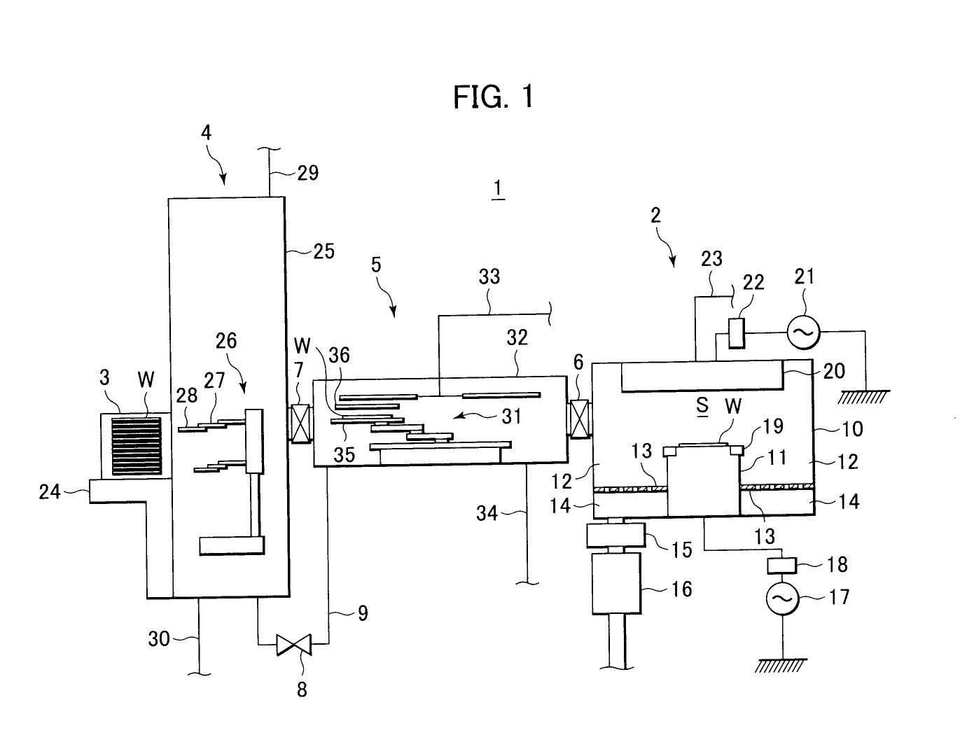

FIG. 1 schematically shows in cross section the construction of the substrate processing apparatus including the gas-tight module according to the embodiment.

As shown in FIG. 1, the substrate processing system 1 includes a process module 2 for carrying out various plasma processing such as film formation, diffusion, etching on each of semiconductor wafers W (hereinafter referred to as “wafers W”) as substrates, a loader module 4 for taking out a wafer W from a wafer cassette 3 adapted to house a predetermined number of wafers W, and a load lock module 5 (gas-tight module) disposed between the loader module 4 and the process module 2 for transferring a wafer W from the loader module 4 to the process module 2 or from the process module 2 to the loader module 4.

The process module 2 is connected to the load lock module 5 via a gate valve 6, and the load lock module 5 is connected to the loader module 4 via a gate valve 7. The inside of the load lock module 5 is communicated with the inside of the loader module 4 via a communication pipe 9 having an openable/closable valve 8 disposed in the middle thereof.

The process module 2 has a cylindrical chamber 10 made of metal such as aluminum or stainless steel. In the chamber 10, there is disposed as a mounting table a column-shaped susceptor 11 on which a wafer W having a 300 mm diameter, for example, is placed.

Between a peripheral wall of the chamber 10 and the susceptor 11, an exhaust path 12 is defined that functions as a flow path through which a gas in a processing space S, described later, is exhausted to the outside of the chamber 10. An annular exhaust plate 13 is disposed in the middle of the exhaust path 12. On the downstream side of the exhaust plate 13, there is provided a manifold 14 which is a downstream-side space of the exhaust path 12. The manifold 14 is communicated with an automatic pressure control valve (hereinafter referred to as the “APC valve”) 15, which is a variable butterfly valve. The APC valve 15 is connected to a turbo-molecular pump (hereinafter referred to as the “TMP”) 16, which is an exhausting pump for evacuation. The exhaust plate 13 prevents a plasma generated in the processing space S from flowing into the manifold 14, the APC valve 15 controls the pressure in the chamber 10, and the TMP 16 depressurizes the inside of the chamber 10 to a substantially vacuum state.

A high-frequency power supply 17 is connected via a matcher 18 to the susceptor 11 for supplying high-frequency power to the susceptor 11. The susceptor 11 therefore functions as a lower electrode. The matcher 18 reduces the reflection of high-frequency power from the susceptor 11, thereby maximizing the efficiency of supply of the high-frequency power to the susceptor 11.

There is disposed on the susceptor 11 an electrode plate (not shown) for attracting and holding a wafer W through a Coulomb force or a Johnsen-Rahbek force. The wafer W is therefore attracted to and held on an upper surface of the susceptor 11. Furthermore, an annular focus ring 19 made of silicon (Si) or the like is disposed at an upper part of the susceptor 11 for focusing plasma generated in the processing space S toward the wafer W between the susceptor 11 and a shower head 20, described below.

Inside the susceptor 11, there is provided an annular coolant chamber (not shown) into which a coolant, for example cooling water, at a predetermined temperature is supplied for circulation. A temperature at which the wafer W on the susceptor 11 is processed is adjusted by the temperature of the coolant. Helium gas is supplied to between the wafer W and the susceptor 11 for transfer of heat from the wafer W to the susceptor 11.

A disk-shaped shower head 20 is disposed at a ceiling portion of the chamber 10. A high-frequency power source 21 is connected via a matcher 22 to the shower head 20 for supplying high-frequency power to the shower head 20. The shower head 20 therefore functions as an upper electrode. The matcher 22 has the same function as that of the matcher 18.

The shower head 20 is connected to a processing gas introduction pipe 23 for being supplied with a processing gas, e.g., a mixture gas of CF-based gas and other kind of gas. The processing gas supplied from the pipe 23 to the shower head 20 is introduced into the processing space S.

In the processing space S in the chamber 10 of the process module 2, the susceptor 11 and the shower head 20 are supplied with the high-frequency power for applying the high-frequency power to the processing space S. In the processing space S, a high density plasma is generated from the processing gas. The generated plasma is focused on a surface of a wafer W by the focus ring 19, and physically or chemically etches the surface of the wafer W, for example.

The loader module 4 includes a wafer-cassette mounting table 24 on which the wafer cassette 3 is mounted, and includes a transfer chamber 25. In the wafer cassette 3, e.g., twenty-five wafers W are disposed in multistage at equal pitch. The transfer chamber 25 is a rectangular parallelpiped box and includes therein a SCARA-type transfer arm 26 for transfer of a wafer W.

The transfer arm 26 has a multi-joint transfer arm portion 27 adapted to be bent and stretched, and a pick 28 mounted to a tip end of the transfer arm portion 27. The pick 28 is configured to be directly mounted with a wafer W. The transfer arm 26 is configured for being turned, and for being bendable/stretchable at the transfer arm portion 27. Thus, the transfer arm 26 is able to transfer a wafer W mounted on the pick 28 between the wafer cassette 3 and the load lock module 5.

A flow-in pipe 29 through which air flows into the transfer chamber 25 is connected to a ceiling portion of the transfer chamber 25, and a flow-out pipe 30 through which air in the transfer chamber 25 flows out is connected to a bottom portion of the transfer chamber 25. In the transfer chamber 25, air flowing thereinto via the ceiling portion of the transfer chamber 25 flows out from the bottom portion of the chamber 25, and therefore the air flowing into the transfer chamber 25 flows downwardly.

The load lock module 5 includes a chamber 32 in which is disposed a transfer arm 31 configured for being bent, stretched, and turned, a gas supply system 31 (gas supply unit) for supplying purge gas such as nitrogen (N₂) gas and substitute gas such as helium (He) gas into the chamber 32, and a load lock module exhaust system 34 for vacuum-exhausting the inside of the chamber 32. The transfer arm 31 is a SCARA-type transfer arm comprised of a plurality of arm portions and having a tip end thereof mounted with a pick 35. The pick 35 is configured to be directly mounted with a wafer W. Furthermore, a plate-like member 36 is disposed in the chamber 32. During the chamber 32 being vacuum-exhausted, the plate-like member 36 faces the pick 35 that holds the wafer W at one place in the chamber 32. In other words, the plate-like member 36 is disposed to face a principal surface of the wafer W transferred into the chamber 32.

The plate-like member 36 has substantially the same size as the wafer W and covers substantially the entire surface of the wafer W when facing the principal surface of the wafer W. At that time, an exhaust passage isolated from the remaining space in the chamber 32 is defined by the wafer W and the plate-like member 36 at a location right above the principal surface of the wafer W.

Upon transfer of a wafer W from the loader module 4 to the process module 2, the transfer arm 31 receives the wafer W from the transfer arm 26 in the transfer chamber 25 at atmospheric pressure, with the gate valve 7 open. The inside of the chamber 32 is then vacuum-exhausted to a predetermined pressure, with the gate valve 7 closed. Subsequently, the transfer arm 31 enters inside the chamber 10 of the process module 2 with the gate valve 6 open, and mounts the wafer W on the susceptor 11. On the other hand, upon transfer of a wafer W from the process module 2 to the loader module 4, the transfer arm 31 enters inside the chamber 10 of the process module 2 and receives the wafer W from the susceptor 11, with the gate valve 6 open. Then, the inside of the chamber 32 is restored to atmospheric pressure, with the gate valve 6 closed. Subsequently, the transfer arm 31 transfers the wafer W to the transfer arm 26 in the transfer chamber 25, with the gate valve 7 open. Operations of the process module 2, the loader module 4, and the load lock module 5, which constitute the substrate processing system 1, are controlled by a computer (not shown) as a controller provided in the substrate processing system 1 or by an external server (not shown) or the like as a controller connected to the substrate processing system 1.

The following is a description of an exhaust method for the load lock module, which is the gas-tight module of this embodiment.

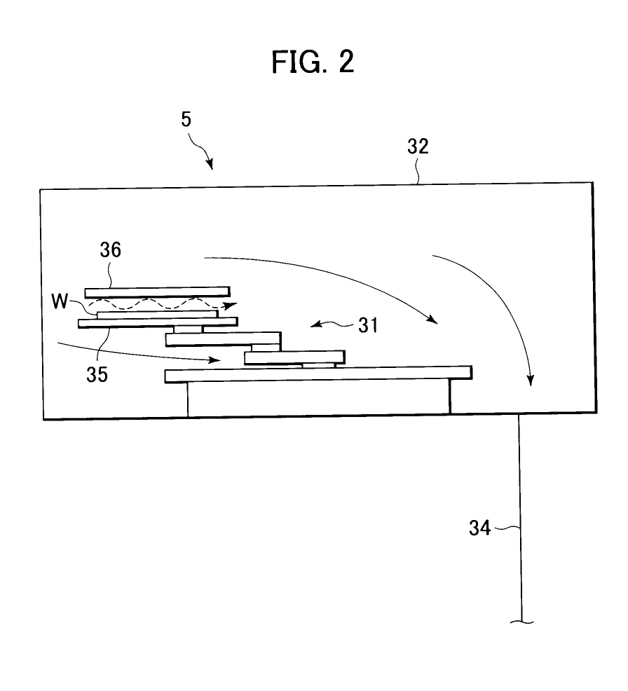

FIG. 2 shows an exhaust process as an exhaust method for the load lock module. In a case, for example, that a wafer W formed with a pattern on its principal surface by being subjected to plasma processing described above is transferred from the loader module 4 to the process module 2, the exhaust process is carried out after the wafer W is received in the chamber 32 at atmospheric pressure.

As shown in FIG. 2, the transfer arm 31 of the load lock module 5 receives the wafer W from the transfer arm 26 in the transfer chamber 25, transfers the wafer W into the chamber 32, and places the wafer W in the chamber 32 such that the principal surface of the wafer W faces the plate-like member 36. After that, the load lock module exhaust system 34 vacuum-exhausts the inside of the chamber 32.

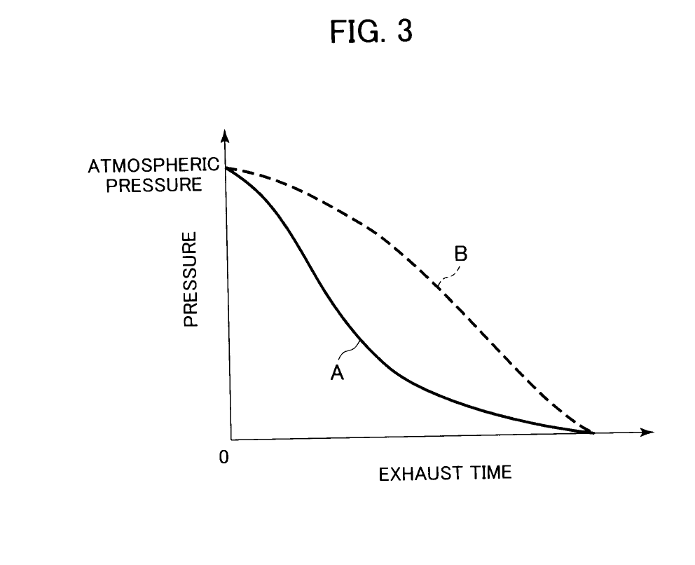

FIG. 3 shows in graph a relation between pressure in the chamber of the load lock module and exhaust time for which the chamber is vacuum-exhausted.

In FIG. 3, a dotted line B indicates a pressure transition in the exhaust passage defined by the wafer W and the plate-like member 36, and a solid line A indicates a pressure transition in the remaining space in the chamber 32.

Since the remaining space in the chamber 32 is large in conductance, the pressure in the remaining space in the chamber 32 is rapidly lowered at an initial stage of vacuum exhaustion. On the other hand, the pressure is gradually lowered in the exhaust passage, which is defined by the wafer W and the plate-like member 36 and smaller in conductance than the remaining space in the chamber 32. This makes it possible to reduce the exhaust speed in the exhaust passage, whereby the kinetic momentum of gas molecules in the exhaust passage can be reduced.

With the above described exhaust process, the plate-like member 36 is disposed such as to face the principal surface of a wafer W, and the exhaust passage isolated from the remaining space in the chamber 32 is therefore defined by the wafer W and the plate-like member 36 at a location right above the principal surface of the wafer W. Since the exhaust passage is smaller in cross section than the remaining space in the chamber 32, it is possible to make the conductance of the exhaust passage, i.e., the conductance at a location right above the principal surface of the wafer W (hereinafter referred to as the “right above conductance”), to be smaller than that of the remaining space in the chamber 32. As a result, at the time of vacuum exhaustion, the kinetic momentum of gas molecules right above the principal surface of the wafer W, i.e., the kinetic momentum of gas molecules present between portions of a pattern formed on the principal surface of the wafer W, is decreased, and therefore the pattern is hardly collapsed by the collision of the gas molecules with the pattern. Furthermore, in the chamber 32, the exhaust flow rate right above the principal surface of the wafer W is relatively extremely small, and therefore a change in the right above conductance hardly affects the conductance of the exhaust flow in the entire chamber 32. As a result, the exhaust time at the vacuum exhaustion is not made long. It is therefore possible to prevent the collapse of the pattern formed on the principal surface of the wafer W, without lowering the throughput of the substrate processing system 1.

The present inventor confirmed that in order to prevent the pattern collapse, the right above conductance should preferably be decreased to a value equal to or less than one tenth of the conductance observed when the plate-like member 36 is not provided. Specifically, for an arrangement where the exhaust passage defined by the wafer W and the plate-like member 36 has a length of 379 mm in the direction of exhaust flow (in the left-to-right direction in FIG. 2) and a length of 309 mm in the direction extending perpendicular to the gas flow direction in the chamber 32 (in the depth direction in FIG. 2), and a distance between the principal surface of the wafer W transferred into the chamber 32 and the ceiling portion of the chamber 32 facing the principal surface is equal to 15.7 mm, it is preferable that the plate-like member 36 should be disposed at a distance of 5 mm or less from the principal surface of the wafer in order to attain the conductance small enough to prevent the pattern collapse.

The above described plate-like member 36 may have a mesh structure or a porous structure, or may be one subjected to slit processing. In that case, it is possible to prevent the right above conductance from being excessively small, thereby making it possible to perform rapid vacuum exhaustion of the inside of the chamber 32.

The plate-like member 36 may be formed with a plurality of holes (not shown) extending therethrough. In that case, a part of gas present right above the principal surface of the wafer W passes through these holes and is discharged. Specifically, at the time of vacuum exhaustion, the just-mentioned gas part flows from the principal surface of the substrate toward the plate-like member, i.e., flows in the direction nearly parallel to the pattern formed on the principal surface. As a result, gas molecules present between portions of the pattern and then flowing through the holes for discharge are prevented from colliding with the pattern, whereby the pattern collapse is positively prevented.

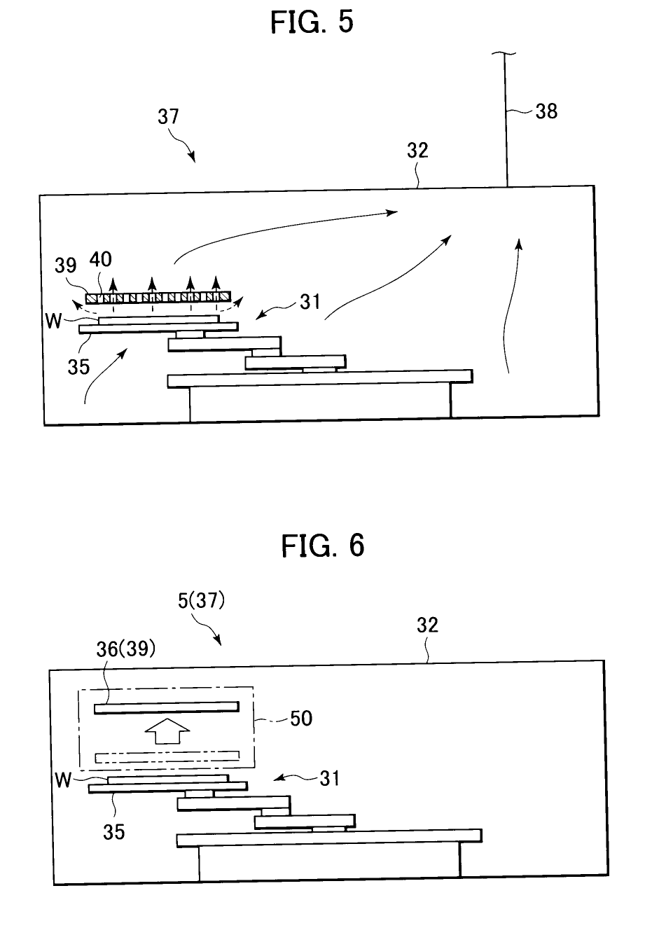

Preferably, the plurality of holes extending through the plate-like member are formed in the direction perpendicular to the principal surface of the wafer W disposed to face the plate-like member (see, FIG. 5 in which a plate-like member 39 formed with holes 40 is shown). In that case, it is ensured that during the vacuum exhaustion, gas passing through the holes flows parallel to the pattern formed on the principal surface of the wafer.

When the inside of the chamber 32 is vacuum-exhausted, there is a fear that particles are stirred up in the chamber and the stirred-up particles fly onto the principal surface of the wafer W. In the load lock module 5, however, since the plate-like member 36 is disposed to face the principal surface of the wafer W, particles flying toward the principal surface of the wafer W are blocked by the plate-like member 36 and unable to reach the principal surface of the wafer W, and therefore the yield of semiconductor devices fabricated on the wafer W can be improved.

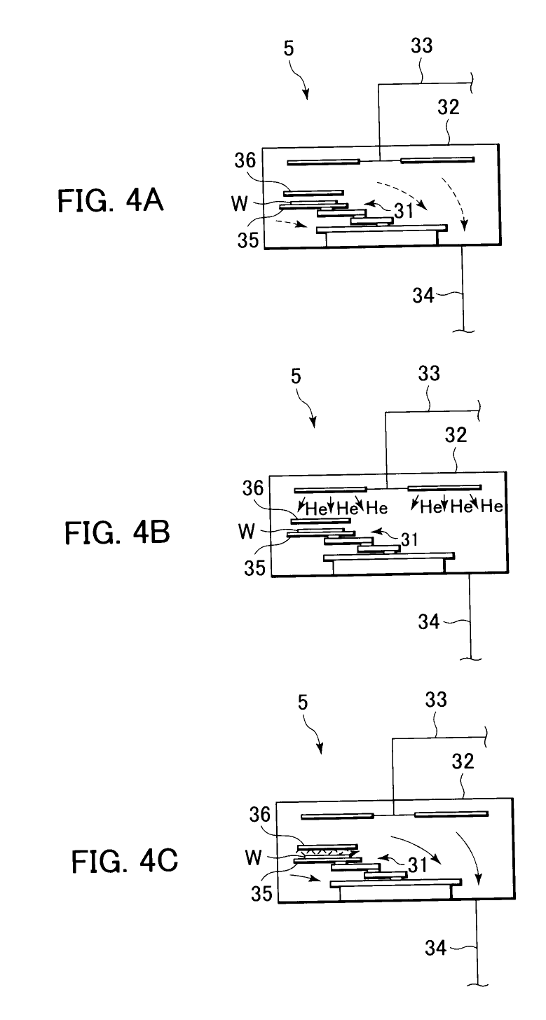

FIG. 4A to FIG. 4C show in process diagram a modification of the exhaust process as an exhaust method for the load lock module which is the gas-tight module according to the embodiment.

First, the transfer arm 31 of the load lock module 5 receives at atmospheric pressure a wafer W from the transfer arm 26 in the transfer chamber 25, transfers the wafer W into the chamber 32, and places the wafer W such that the principal surface of the wafer W faces the plate-like member 36 in the chamber 32. Then, the inside of the chamber 32 is exhausted by the load lock module exhaust system 34 to a low vacuum (FIG. 4A).

Next, helium gas as light element gas is supplied from the gas supply system 33 into the chamber 32 exhausted to a low vacuum (FIG. 4B).

Then, the inside of the chamber 32 is vacuum-exhausted by the load lock module exhaust system 34 (FIG. 4C).

With this modified exhaust process, the plate-like member 36 is disposed to face the principal surface of the wafer W, and therefore effects similar to those attained by the exhaust process described with reference to FIG. 2 can be attained. Furthermore, since helium gas, which is a light element gas, is supplied into the chamber 32 after completion of exhaustion to a low vacuum, gas present in the chamber 32 is replaced by the helium gas. As a result, at the time of vacuum exhaustion, it is possible to further decrease the kinetic momentum of gas molecules present right above the principal surface of the wafer W, i.e., the kinetic momentum of gas molecules present between portions of the pattern formed on the principal surface of the wafer W, whereby the collapse of the pattern on the wafer W can positively be prevented. If the kinetic momentum of gas molecules is not intended to be reduced but may be maintained at a value observed before the replacement by helium gas, the exhaust speed may alternatively be improved to improve the throughput of the substrate processing system 1.

With the modified exhaust process, the kinetic momentum of gas molecules present between portions of the pattern on the principal surface of the wafer W can be decreased by replacing the gas in the chamber 32 by helium gas, which is a light element gas. This makes it possible to prevent the pattern collapse to some extent, even if the plate-like member 36 is not disposed, for example.

FIG. 5 shows an exhaust process as another modification of the exhaust method for the load lock module, which is the gas-tight module according to the embodiment. This exhaust process is performed in the same procedures as the exhaust process described with reference to FIG. 2.

As shown in FIG. 5, a load lock module 37 includes a load lock module exhaust system 38 (exhaust apparatus) disposed above the chamber 32 for exhausting the inside of the chamber 32, and a plate-like member 39 is disposed in the chamber 32 so as to face a wafer mounting surface of a pick 35. The plate-like member 39 is formed with a plurality of holes 40 extending through the plate-like member 39. A transfer arm 31 of the load lock module 37 receives a wafer W at atmospheric pressure from the transfer arm 26 in the transfer chamber 25, transfers the wafer W into the chamber 32, and causes the principal surface of the wafer W to face the plate-like member 39 in the chamber 32. Then the inside of the chamber 32 is vacuum-exhausted from above by the load lock module exhaust system 38.

With this exhaust process, since the plate-like member 39 is disposed to face the principal surface of the wafer W, effects similar to those attained by the exhaust process described with reference to FIG. 2 can be attained. Since the plate-like member 39 has a plurality of holes 40 formed to extend therethrough and gas present inside the chamber 32 is vacuum-exhausted from above, the most part of gas present right above the principal surface of the wafer W is exhausted passing through the holes 40. As a result, at the time of vacuum exhaustion, it is possible to cause a gas flow flowing from a location right above the principal surface of the wafer W in a direction nearly parallel to the pattern formed on the principal surface, whereby gas molecules present between portions of the pattern can be prevented from colliding with the pattern, and therefore the pattern collapse can positively be prevented.

Preferably, the holes 40 extending through the plate-like member 39 are formed in a direction perpendicular to the principal surface of the wafer W disposed to face the plate-like member 39. In that case, at the time of vacuum exhaustion, it is ensured that the gas flow flowing from a location right above the principal surface of the wafer W is directed parallel to the pattern formed on the principal surface.

A plate-like member having a plurality of holes 40 formed perpendicular to the principal surface of the wafer W may be disposed at an upper part in the chamber 32 so as to extend across the space of the chamber 32 and to divide the space into two space parts. In that case, at the time of vacuum exhaustion, there can be produced a gas flow that flows nearly parallel to the pattern on the principal surface of the wafer W in a lower space part of the chamber 32, i.e., in that space part into which a wafer W is transferred.

In the exhaust process shown in FIG. 5, the load lock module exhaust system 38 is disposed above the chamber 32. When the principal surface of the wafer W transferred into the chamber 32 is not directed upward such as for example that it is directed downward, the load lock module exhaust system 38 may be disposed beneath the chamber 32 so as to face the principal surface of the wafer W. In that case, effects similar to those attained by the exhaust process described with reference to FIG. 5 can be attained.

As shown in FIG. 6, the load lock module 5 or 37 in which one of the above described exhaust processes is performed may include a separation unit 50 for separating the plate-like member 36 or 39 from the principal surface of the wafer W. In that case, the separation unit 50 controls an amount of separation between the plate-like member 36 or 39 and the principal surface of the wafer W according to the pressure within the chamber 32 during the vacuum exhaustion. This makes it possible to properly control the right above conductance according to the pressure within the chamber 32 during the vacuum exhaustion. Specifically, the lower the pressure in the chamber 32, the larger the plate-like member 36 or 39 will be separated from the principal surface of the wafer W. As a result, the conductance of the exhaust passage defined by the wafer W and the plate-like member 36 or 39 can gradually be increased, making it possible to rapidly carry out the vacuum exhaustion of the inside of the chamber 32.

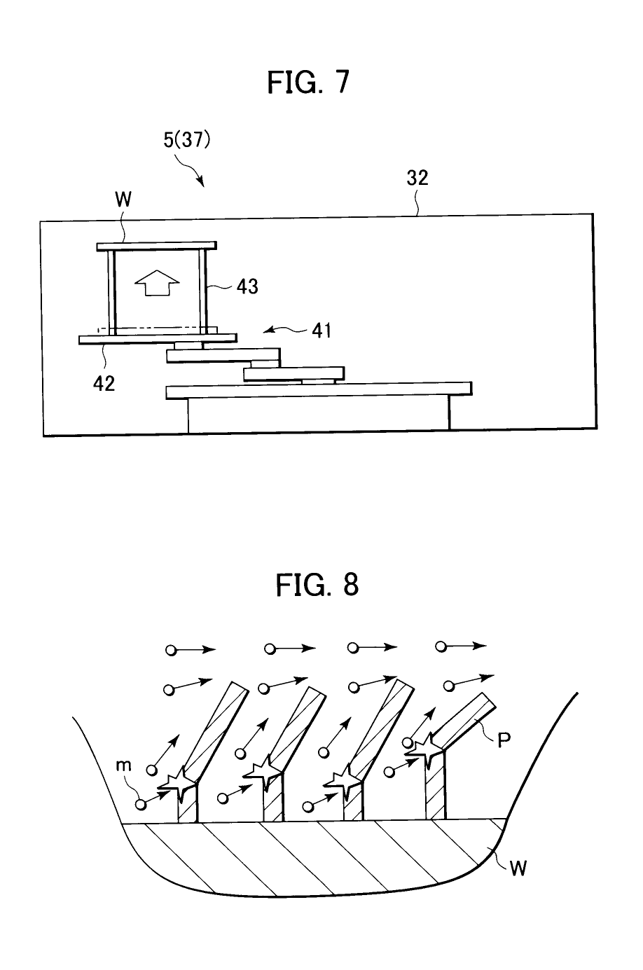

As shown in FIG. 7, a transfer arm 41 having a pick 42 mounted to a tip end of the arm 41 may be disposed in the chamber 32 of the load lock module 5 or 37. The pick 42 includes a plurality of lift pins 43 (substrate lifting unit) for lifting a wafer W placed on the pick 42. The transfer arm 41 of the load lock module 5 or 37 receives a wafer W from the transfer arm 26 in the transfer chamber 25 at atmospheric pressure. After the wafer W is transferred into the chamber 32 by the transfer arm 41, the wafer W is lifted by the lift pins 43 of the pick 42 toward a portion of the chamber which faces the principal surface of the wafer W, i.e., toward the ceiling portion of the chamber 32. At that time, an exhaust passage isolated from the remaining space in the chamber 32 is defined by the wafer W and the ceiling portion of the chamber 32 at a location right above the principal surface of the wafer W. Since the exhaust passage is smaller in sectional area than the remaining space in the chamber 32, the right above conductance can be made small, whereby effects similar to those attained by the exhaust process described with reference to FIG. 2 can be attained.

In the above, the cases where this invention is applied to various load lock modules have been described, however, this invention is also applicable to any other gas-tight modules such as a module or an apparatus having a chamber into which a wafer formed with a pattern is transferred.

In the above described embodiment, the cases where a semiconductor wafer is used as substrate have been described, however, the substrate is not limitative thereto but may be a glass substrate such as a LCD (liquid crystal display) or a FPD (flat panel display).

What is claimed is:

1. A gas-tight module comprising:
a chamber into which is transferred a substrate formed with a pattern on its principal surface by being subjected to predetermined processing; and
a plate-like member disposed to face the principal surface of the substrate transferred into said chamber.

2. The gas-tight module according to claim 1, wherein said plate-like member is disposed at a distance equal to or less than 5 mm from the principal surface of the wafer.

3. The gas-tight module according to claim 1, wherein said plate-like member has a mesh structure or a porous structure.

4. The gas-tight module according to claim 1, wherein said plate-like member is one subjected to slit processing.

5. The gas-tight module according to claim 1, wherein said plate-like member is formed with a plurality of holes extending therethrough.

6. The gas-tight module according to claim 5, wherein the plurality of holes are formed in said plate-like member so as to extend perpendicular to the principal surface of the substrate.

7. The gas-tight module according to claim 5, including an exhaust apparatus disposed to face the principal surface of the substrate and adapted to exhaust inside of said chamber.

8. The gas-tight module according to claim 1, including a gas supply unit adapted to supply a light element gas into said chamber.

9. The gas-tight module according to claim 1, including a separation unit adapted to separate said plate-like member and the principal surface of the substrate away from each other.

10. A gas-tight module comprising:
a chamber into which is transferred a substrate formed with a pattern on its principal surface by being subjected to predetermined processing; and
a substrate lifting unit adapted to lift the substrate toward a portion of said chamber that faces the principal surface of the substrate transferred into said chamber.

11. An exhaust method for a gas-tight module having a chamber into which is transferred a substrate formed with a pattern on its principal surface by being subjected to predetermined processing, the method comprising:
a disposing step of disposing a plate-like member in the chamber so as to face the principal surface of the substrate transferred into the chamber; and
an exhausting step of exhausting inside of the chamber.

12. The exhaust method according to claim 11, including:
a low vacuum exhaustion step of exhausting the inside of the chamber to a low vacuum prior to said exhausting step, and
a gas supply step of supplying a light element gas into the chamber exhausted to the low vacuum.

13. An exhaust method for a gas-tight module having a chamber into which is transferred a substrate formed with a pattern on its principal surface by being subjected to predetermined processing, the method comprising:
a substrate lifting step of lifting the substrate toward a portion of the chamber that faces the principal surface of the substrate transferred into the chamber; and
an exhaust step of exhausting inside the chamber.
